(19) United States
(12) Patent Application Publication
(10) Pub. No.: US 2026/0047525 A1
(43) Pub. Date: Feb. 19, 2026

(54) Palm Seed Pod Puller

(71) Applicant: Wayne M. Brown, Hemet, CA (US)

(72) Inventor: Wayne M. Brown, Hemet, CA (US)

(21) Appl. No.: 18/803,669

(22) Filed: Aug. 13, 2024

(51) Int. Cl. A01D 46/08; B25J 9/10

(52) U.S. Cl. CPC A01D 46/087; B25J 9/109

(57) ABSTRACT

Improvements in a palm seed pod puller that uses a lever arm operates through a pivoting fulcrum to increase the mechanical advantage of a user to pull the seed tassel more easily from the stalk with less effort. A spring directed cam applies force to clamp onto the seed tassel and can increase the gripping force as the stalk is being pulled. The cam rotates to increase the clamping force as the stalk is crushed and flattens. The cam allows the stalk to wrap around the cam to increase the contact surface for clamping. The support post is positioned within the tree and around the palm fronds where the end of the post rests against the tree to provide a base for the fulcrum and lever arm to apply forces in the opposite direction of the pulling forces on the seed tassel.

### CROSS-REFERENCE TO RELATED APPLICATIONS

Not Applicable.

### PRIOR ART

U.S. Pat. No. 1,393,955 issued on Oct. 18, 1921, to T. H. Mork and is titled Cotton Stalk Puller. This patent discloses a stalk puller for pulling the roots of cotton stalks serve as habitats for the boll weevil, as well as other destructive insects, and furthermore, it is well known that failure to remove the roots of the stalk curtails production of the ensuing crop. The stalk puller is essentially an elongated shaft with a tapered opening for grasping the stalk to uproot the stalk from the ground. While this patent discloses a device to pull a stalk the device relies upon the using the tip of the shaft for an anchor and the taper to grasp the stalk. It does not disclose a cam to grasp the stalk and requires a rigid stalk.

U.S. Pat. No. 6,302,376 issued on Oct. 16, 2001, to John Williams and is titled Self-translating Stake Puller. This patent discloses a tool for removing stakes from the ground, or any other medium. More specifically, this invention is directed to a stake puller which freely translates the lateral forces normally exerted by the ground on a stake during removal of the stake at an angle different from that at which it entered the ground. This self-translating stake puller according to the invention comprises a lever arm having opposing first end and second end; a stake engaging mechanism attached to the second end of the lever arm, and configured to pivot the stake about the second end; and, a fulcrum having a top end and a bottom end, wherein the top end is pivotally attached to the lever arm between the first end and the second end, such that the fulcrum plane of pivot is generally parallel to the plane of pivot of the stake about the second end, and wherein the bottom end of the fulcrum is of a size and shape such that the fulcrum can rock easily on the bottom end. While this patent discloses a device for pulling a stake from the ground it does not allow for grasping a thin flexible seedpod stalk.

U.S. Pat. No. 6,910,664 issued on Jun. 28, 2005, to Bruce Bolinder et al and is titled Removable Sign Support System. This patent discloses. While this patent discloses a removable sign support system for supporting a sign on the ground includes a substantially upright support post, configured to removably receive a signpost. The support post has a substantially horizontal base affixed to its bottom end, with a plurality of spikes downwardly extending from the base into the ground, and a lifting connection fixedly attached to the support post. A removal device is provided for removing the support post from the ground and includes a moveable column having a bottom end configured to bear upon the top of the ground near the base of the support post, and a lever arm pivotally attached to the moveable column. The removal device is configured to pull the spikes upwardly out of the ground by engaging the lever arm with the lifting connection and applying a substantially upward force thereon. This patent does not include a cam for grasping a stalk.

What is needed is a seed pod puller that includes a grasping cam that can be positioned in a tree with an adjustable fulcrum to pull seed pods from palms or other plants. The palm seed pod puller disclosed in this document provides the solution.

### BACKGROUND OF THE INVENTION

Mature palm trees or pigmy palm trees sprout seed pods in the head or fronds of the tree. When these seed pods open and produce fruit, they can release hundreds or thousands of seeds for future trees. Each tree can produce one to dozens of seed pods each year. One option is to trim the seed pods, but this can still result in some future fruit generation if the entire seed pod is not removed. A person can try and grasp the seed pod and try to pull the stalk if they can exert sufficient force. If the seed pods are removed completely from the tree the entire process of fruit production is eliminated. A tool must be positioned within the tree and configured to grasp the flexible stalk to pull the stalk from the trunk of the tree using a lever arm with a mechanical advantage.

### SUMMARY OF THE INVENTION

It is an object of the palm seed pod puller to include a lever arm to reduce the user force that is required. The lever arm operates through a pivoting fulcrum to increase the mechanical advantage of a user to pull the seed tassel more easily from the stalk with less effort. The length of the lever arm and the location of the pivoting fulcrum can be adjusted to alter the force and stroke length depending upon the age of the tree, pulling distance and the required extraction force.

It is an object of the palm seed pod puller to include a gripping cam to grasp the stalk of the tree. The cam applies force to clamp onto the seed tassel and can increase the gripping force as the stalk is being pulled. The cam rotates to increase the clamping force as the stalk is crushed and flattens. The cam also allows the stalk to wrap around the cam at least partially to further increase the contact surface for clamping.

It is another object of the palm seed pod puller is to have a post that is positioned within the tree as an anchor location. The post is an elongated member that is positioned within the tree and around the palm fronds where the end of the post rests against the tree to provide a base for the fulcrum and lever arm to apply forces in the opposite direction of the pulling forces on the seed tassel.

It is another object of the palm seed pod puller to have a handle for a user to grip. The handle provides a cushioned surface and a gripping location at or near the end of the lever arm for a user to apply forces. This improves comfort and may provide finger wells to improve a grip and identify a preferred location for using the palm seed pod puller.

It is still another object of the palm seed pod puller to include a spring to maintain the position of the cam. The spring is opened when the lever arm is opened and closes the cam on the stalk when forces are being applied. This reduces the need for the user to articulate the cam and possibly clamping the gripping mechanism on an appendage of a user.

Various objects, features, aspects, and advantages of the present invention will become more apparent from the following detailed description of preferred embodiments of the invention, along with the accompanying drawings in which like numerals represent like components.

### BRIEF DESCRIPTION OF DRAWINGS

FIG. 1 shows a perspective view of a palm seed pod puller.

FIG. 2 shows a detailed view of the cam gripper.

FIGS. 3A-3D show progressive stages of using the palm seed pod puller to remove a palm seed pod.

FIG. 4 shows removing the palm seed pod from the palm seed pod puller.

### DETAILED DESCRIPTION OF THE INVENTION

It will be readily understood that the components of the present invention, as generally described and illustrated in the drawings herein, could be arranged and designed in a wide variety of different configurations. Thus, the following more detailed description of the embodiments of the system and method of the present invention, as represented in the drawings, is not intended to limit the scope of the invention but is merely representative of various embodiments of the invention. The illustrated embodiments of the invention will be best understood by reference to the drawings, wherein like parts are designated by like numerals throughout.

While this technology is susceptible of embodiment in many different forms, there is shown in the drawings and will herein be described in detail several specific embodiments with the understanding that the present disclosure is to be considered as an exemplification of the principles of the technology and is not intended to limit the technology to the embodiments illustrated. The terminology used herein is for the purpose of describing particular embodiments only and is not intended to be limiting of the technology. As used herein, the singular forms “a,” “an,” and “the” are intended to include the plural forms as well, unless the context clearly indicates otherwise.

It will be further understood that the terms “comprises,” “comprising,” “includes,” and/or “including,” when used in this specification, specify the presence of stated features, integers, steps, operations, elements, and/or components, but do not preclude the presence or addition of one or more other features, integers, steps, operations, elements, components, and/or groups thereof. It will be understood that like or analogous elements and/or components, referred to herein, may be identified throughout the drawings with like reference characters.

Item Numbers and Description

| | |
|---|---|
| 20 palm seed pod puller | 29 spring |
| 30 handle | 31 fulcrum pivot |
| 32 end pivot | 37 first dimension |
| 38 second dimension | 39 grip |
| 40 leg | 41 leg tip |
| 50 arm | 51 cam axle |
| 59 fastener | 60 cam |
| 61 teeth | 69 broken lines |
| 70 compression plate | 71 platen |
| 80 palm seed pod | 95 pull |
| 96 pull | 97 pull |
| 98 rotate | 99 insert |

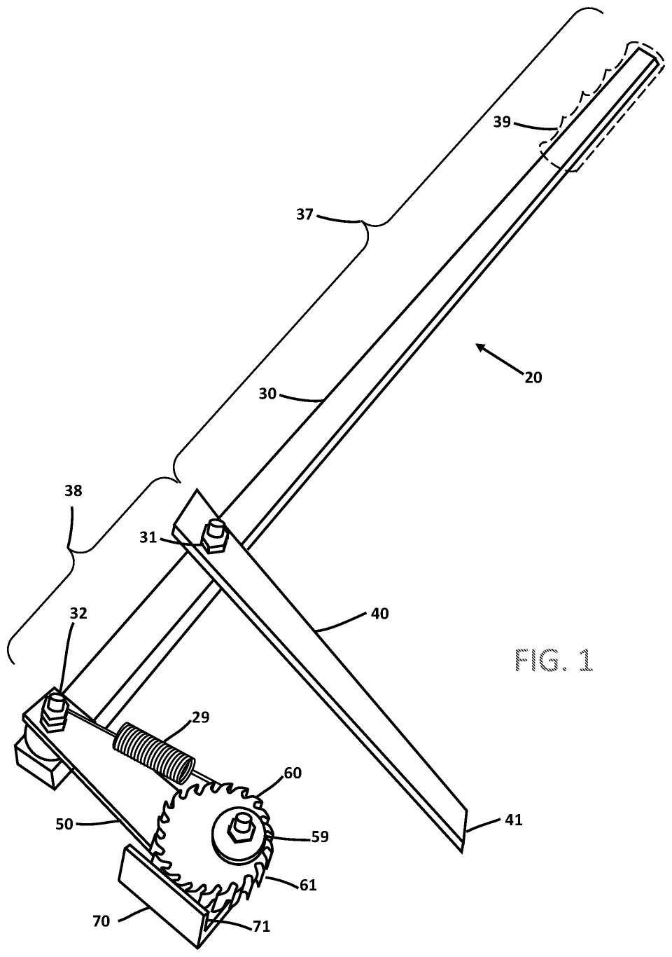

FIG. 1 shows a perspective view of a palm seed pod puller 20. The basic parts of the palm seed pod puller 20 are a handle 30, a leg 40, and an arm 50 having a cam 60 and a compression plate 70.

Leg 40 is connected to the handle 30 through a pivot axis (bolt) or fulcrum pivot 31. In the preferred embodiment the handle has a first dimension or length 37 at one a first side of the fulcrum pivot 31 and a second dimension or length 38 at a second side of the fulcrum pivot 31. An optional grip 39 is shown to position and cushion the area where a user can grip the palm seed pod puller 20. The first length 37 being longer than the second length 38 to provide a mechanical advantage for movement of the arm 50. One end of the leg 40 is secured to the handle with a pivoting mechanism, fulcrum pivot 31. In this preferred embodiment the pivoting mechanism is a bolt, or a shoulder bolt secured with a nut through one or more washers, bushings, or bearings (not shown). The distal end of the leg is a leg tip 41, foot or point that is configured to temporally embed in the head of a palm tree.

Arm 50 is secured to the handle 30 with a pivoting mechanism at an end pivot 32. In this preferred embodiment the end pivot 32 mechanism is a bolt, or a shoulder bolt secured with a nut through one or more washers, bushings or bearings. The arm 50 has a compression plate 70 with a platen 71 surface that faces the cam 60. The cam 60 has one-way teeth 61 or similar gripping mechanism that traps and holds a seed pod (not shown). Spring 29 biases the cam 60 against the platen 71 surface. As the seed pod is pulled the pressure on the seed pod between the cam 60 and the pressure plate 70 platen 71 increases. In the preferred embodiment, the spring 29 is shown as a compression spring, but the spring 29 in the palm seed pod puller 20 could be designed as a compression spring or as a torsional spring. The cam 60 is configures as an eccentric wheel on the arm 50 and is secured with a fastener 59. In the preferred embodiment the fastening mechanism 59 is a bolt or a shoulder bolt secured with a nut through one or more washers, bushings or bearings.

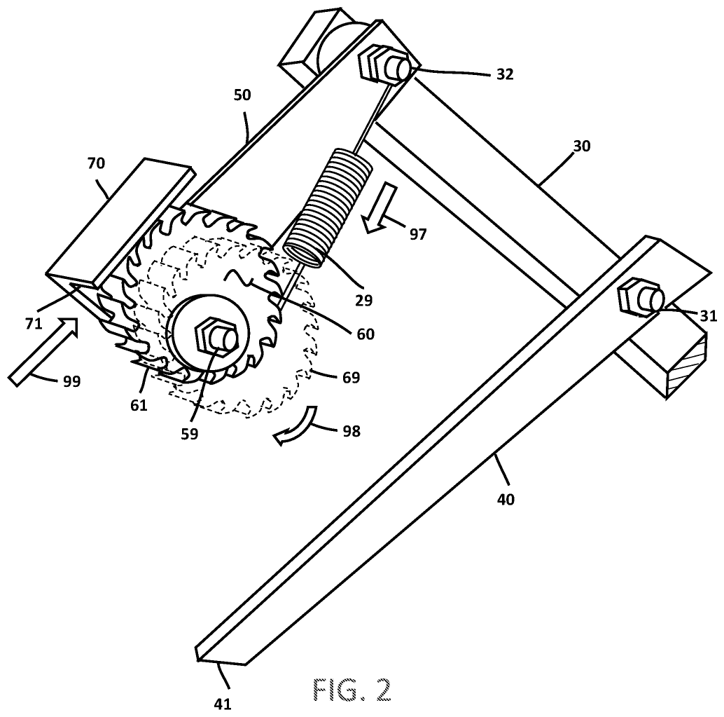

FIG. 2 shows a detailed view of the cam gripper 60. In this figure the gripping teeth 61 are more visible and are angled to “dig” into the seed stalk (not shown) that would be inserted 99 or placed into the palm seed pod puller 20. A portion of handle 30 has been shown broken-away near the fulcrum point 31 to enlarge the remainer of the components in the figure. The leg 40 and the leg tip 41 are visible in this figure. The palm seed pod puller 20 is open on one side to allow for placement of a seed pod stalk into the cam 30 from the open side of the palm seed pod puller 20.

When a stalk is placed or pushed 99 into the open side of the palm seed pod puller 20 it will rotate 98 the cam 60 wheel and extend or pull 97 the extension spring 29 that is shown as a compression spring, but the spring 29 in the palm seed pod puller 20 could be designed as a compression spring or as a torsional spring. Broken lines 69 shows a rotated cam. The spring 29 is connected to the palm seed pod puller 20 at a first end on the end pivot 32 where the second end of the handle 30 is secured to the arm and the other or distal end of the spring 29 is connected to the cam 60 with a fastener or similar retaining mechanism that will be shown in more detail in other figures herein. Cam 60 is secured to the arm 50 with fastener 59. In the preferred embodiment the fastening mechanism 59 is a bolt or a shoulder bolt secured with a nut through one or more washers, bushings or bearings.

Arm 50 is shown with compression plate 70 having a platen 71 surface that faces the cam 60. This provides a surface to compress the seed pod shaft between the cam 60 and the platen 71. The platen 71 is shown as a flat surface, but could be curved, and it is also contemplated that the platen 71 could be replaced with a complementary cam thereby having two facing cams for gripping a seed pod shaft.

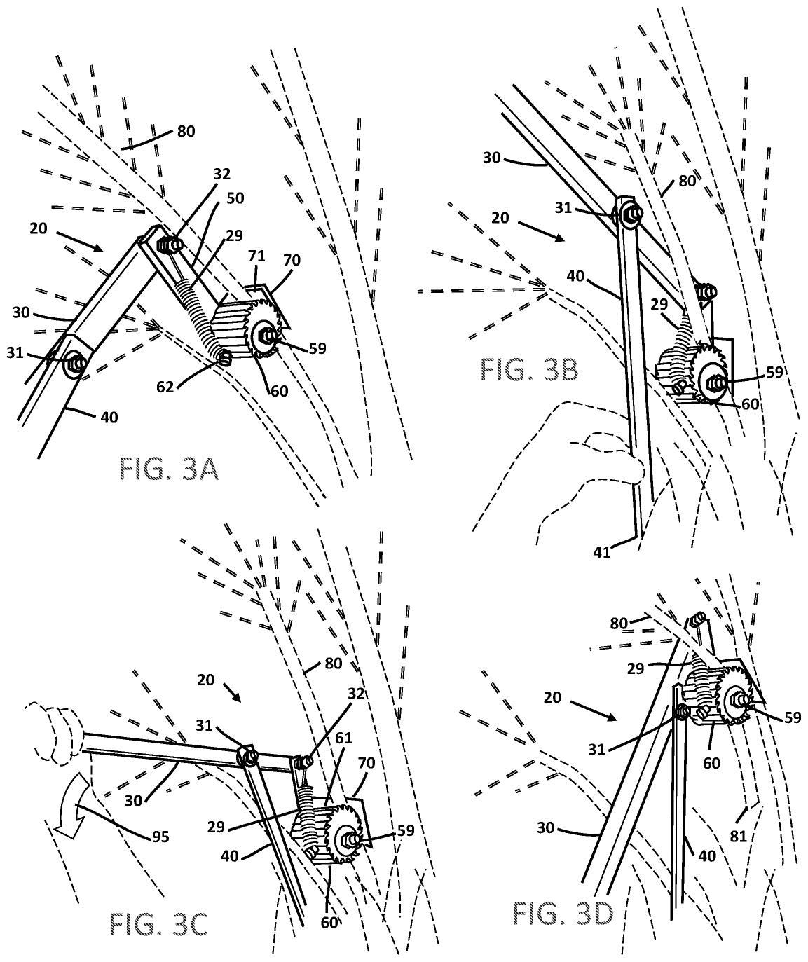

FIGS. 3A-3D show progressive stages of using the palm seed pod puller 20 to remove a palm seed pod 80. Item numbers may or may not appear in each of these figures but represent the same (or similar) item, element, or feature.

Starting from FIG. 3A the seed stalk 80 is brought into the open side of the palm seed pod puller 20. The spring 29 force on the cam 60 is sufficiently set to allow the cam 60 to open, as it turns on the fastener 59, when the seed stalk 80 is inserted from the side or the cam 60 can be manually rotated to increase the opening between the cam teeth 61 and the platen 71 of the compression plate 70. In this figure the second end of the spring 29 is shown secured to the outer surface of the cam 60 with a fastener 62 but could also be pressed not a hole or recess in the cam 60.

Moving to FIG. 3B, the handle 30 is lifted and the leg 40 pivots, or swings from the fulcrum point 31 is brought into a location on the head of the palm tree so the leg tip 41 can “grab or bite” into the head of the palm tree for a secure base to push against. The teeth 61 on the cam 60 are angled to allow the cam to easily slide down the length of the seed pod stalk 80 as the spring 29 retains pressure of the cam 60 on the seed stalk onto the compression plate 70. It is important to locate the tip 41 so the downward stroke of the handle 30 provides a sufficient pull on the stalk 80 to completely remove the stalk from the palm tree.

From FIG. 3C the user pulls down 95 on the handle 30 the compression plate 70 can pivot at end point 32 such that the arm 50 of the compression plate 70 is mostly parallel with the leg 40. The teeth 61 of the cam 60 will grip into the fibrous material of the seed stalk 80 and the forces will overcome the retention forces holding the seed stalk 80 in the head of the palm tree.

In FIG. 3D the end of the seed stalk 81 has been pulled clean from the sheath. At this point in the seed pod removal the seed pod 80 is free from the palm tree and is being retained in the palm seed pod puller 20 between the cam 60 and the compression plate 70 platen 71.

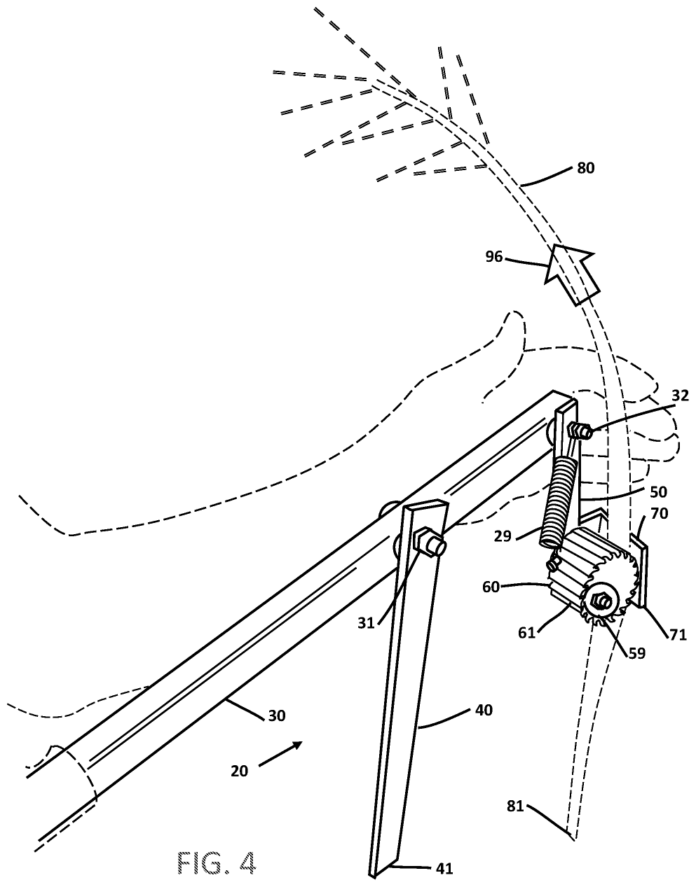

FIG. 4 shows removing the palm seed pod from the palm seed pod puller 20. At this stage, the seed pod 80 retained in the palm seed pod puller 20 between the cam 60 and the platen 71 and can be cleared from the palm tree. The user can pull 96 the seed pod 80 through the opposite direction of the cam 60 where it can be discarded. The palm seed pod puller 20 can then be reused to remove additional seed pods.

Thus, specific embodiments of a palm seed pod puller have been disclosed. It should be apparent, however, to those skilled in the art that many more modifications besides those described are possible without departing from the inventive concepts herein. The inventive subject matter, therefore, is not to be restricted except in the spirit of the appended claims.

1. A palm seed pod puller comprising:
a lever having a first end and a second end;
a leg pivotally connected to said lever between said first end and said second end wherein said leg pivotally connected forms a fulcrum on said lever;
said fulcrum is pivotally connected in a planar relationship to said leg;
an arm pivotally connected to said lever at said second end;
said arm has a pressure plate and a cam, and
said cam is configured to rotate into said pressure plate to grip a flexible plant stalk or seed pod therein between.

2. The palm seed pod puller according to claim 1, wherein said cam has a plurality of gripping teeth.

3. The palm seed pod puller according to claim 1, wherein said gripping teeth are configured to grip in only one direction.

4. The palm seed pod puller according to claim 2, further includes a spring that provides pressure between said cam and said pressure plate.

5. The palm seed pod puller according to claim 4, wherein said spring is an extension spring, a compression spring or a torsion spring.

6. The palm seed pod puller according to claim 4, wherein a first end of said spring is secured to said cam and a second end of said spring is connected to said lever arm at said second end of said lever.

7. The palm seed pod puller according to claim 1, wherein a distance between said first end of said lever arm and said leg is greater than a distance between said second end of said lever arm and said leg.

8. The palm seed pod puller according to claim 1, wherein said lever arm further includes a hand grip.

9. The palm seed pod puller according to claim 1, wherein said pivotal connection of said leg to said lever is with a bolt, shoulder bolt or a bearing.

10. The palm seed pod puller according to claim 1, wherein said cam is pivotably secured to said arm.

11. The palm seed pod puller according to claim 1, wherein said cam is pivotally connected in a planar relationship to said pressure plate.

12. The palm seed pod puller according to claim 1, wherein said arm is pivotally connected in a planar relationship to said lever.

13. The palm seed pod puller according to claim 1, wherein said cam is pivotally connected in a planar relationship to said arm.

14. The palm seed pod puller according to claim 11, wherein said pivotal connection of said cam to said pressure plate is with a bolt, shoulder bolt or a bearing.

15. The palm seed pod puller according to claim 14, wherein said spring is connected to said cam with a fastener.

16. The palm seed pod puller according to claim 1, wherein said leg includes a point or a foot.

17. The palm seed pod puller according to claim 1, wherein said spring is connected to said cam with a recess or a hole in said cam.

18. The palm seed pod puller according to claim 2, wherein a normal length of said spring is selected to provide a gap between said teeth of said cam and a platen on said pressure plate.

19. The palm seed pod puller according to claim 18, wherein inserting flexible plant stalk or seed pod between said platen and said teeth of said cam increases said gap between said teeth of said cam and a platen on said pressure plate.

20. The palm seed pod puller according to claim 1, wherein rotation of said cam in a first direction increases pressure on said flexible plant stalk or seed pod and rotation of said cam in direction that is opposite of said first direction decreases a tension on said flexible plant stalk or seed pod.
